(19) United States
(12) Patent Application Publication
(10) Pub. No.: US 2011/0085882 A1
(43) Pub. Date: Apr. 14, 2011

(54) Method and Apparatus for Moving and Collecting Open-Ended Containers

(75) Inventors: Robin G. Thurgood, Marshall, MI (US); Brian C. Bowerman, Quincy, MI (US)

(73) Assignee: Rennco LLC, Homer, MI (US)

(21) Appl. No.: 12/575,681

(22) Filed: Oct. 8, 2009

(51) Int. Cl. B65G 57/00; B65G 57/16; B65B 35/50; B65G 47/26; B65G 37/00

(52) U.S. Cl. 414/798.4; 414/801

(57) ABSTRACT

A collecting apparatus and method for moving and nesting open-ended containers, where the open-ended containers have a diameter which is greater than the depth of the open-ended container.

### TECHNICAL FIELD

The present application relates to machines and methods for use in moving and collecting containers, particularly open-ended containers having a diameter which is greater than their depth.

### BACKGROUND

During manufacturing and/or packaging of open-ended containers, it is often convenient to arrange the containers in a nested configuration where one container is at least partially inserted into another container. This minimizes the space occupied by the open-ended containers and thus allows easier packaging and/or transporting. For example, cups are often packaged, transported, and sold as stacks of nested containers. The nesting of cups can be accomplished by compressing a plurality of cups that are in a line, for example, laying on their side with their open-ends all facing the same direction. This method of nesting cups is possible because the diameter of the cups are less than the depth or height, and therefore, cups can be positioned on their sides unaided. However, if the open-ended container has a diameter which is greater than its depth, for example in a tub, the container will be unstable when placed on its side to facilitate nesting. Thus, there is a need for a method and apparatus which is capable of collecting open-ended containers such as tubs. In particular, a method and apparatus capable of aligning and moving open-ended containers such that the containers can be collected in a nested configurations.

### SUMMARY

In an aspect, a collecting apparatus for receiving and moving open-ended containers is provided, wherein the open-ended containers have a diameter which is greater than its depth. In one embodiment, the apparatus comprises a frame having a lengthwise axis which defines an open-ended container travel path from an inlet end to an outlet end, a carriage mounted for reciprocating movement parallel to the travel path, and at least two retractable pushers associated with the carriage for movement therewith, the pushers movable between respective retracted positions outside of the travel path and respective extended positions in which the pushers are moved into the travel path for engaging containers, wherein the carriage is moved along the travel path toward the outlet end with the pushers in the respective extended positions for moving containers along the travel path.

In another aspect, a method of collecting and moving open-ended containers of a type in which a container diameter is greater than a container depth is provided. In one embodiment, the method comprises engaging at least two points of a portion of a first open-ended container at a start position with at least two pushers, each finger associated with a carriage which is capable of reciprocating movement between the start position and an end position, moving the first open-ended container in a travel path direction away from the start position toward the end position using the two pushers, a depthwise axis of the container being substantially parallel to the travel path direction during the moving, disengaging the at least two pushers from the portion of the first open-ended container and returning the carriage to the start position, including retracting the pushers past at least a portion of a second open-ended container, and extending the pushers and engaging at least two points on the second open-ended container with the pushers; moving the second open-ended container toward the first open-ended container using the two pushers so as to nest the second open-ended container with the first open-ended container.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 shows a collecting apparatus in one embodiment.

FIG. 2 shows a first open-ended container in association with a collecting apparatus in one embodiment.

FIG. 3 shows pushers of a collecting apparatus engaging a first open-ended container in one embodiment.

FIG. 4 shows movement of a first open-ended container in a travel path direction in a collecting apparatus in one embodiment.

FIG. 5 shows pushers of a collecting apparatus disengaging a first open-ended container in one embodiment.

FIG. 6 shows the return of a carriage containing pushers of a collecting apparatus towards an inlet side of a collecting apparatus in one embodiment.

FIG. 7 shows pushers of a collecting apparatus engaging a second open-ended container in one embodiment.

FIG. 8 shows movement of a second open-ended container in a travel path direction in a collecting apparatus and collection of the first and second open-ended containers in one embodiment.

FIG. 9 shows pushers of a collecting apparatus disengaging a second open-ended container in one embodiment.

FIG. 10 shows the return of a carriage containing pushers of a collecting apparatus towards an inlet side of a collecting apparatus in one embodiment.

FIG. 11 shows introduction of a third open-ended container into the collecting apparatus in one embodiment.

FIG. 12 shows an open-ended container according to one embodiment.

FIG. 13 shows a collecting apparatus along with up-stream and down-stream components according to one embodiment.

### DETAILED DESCRIPTION

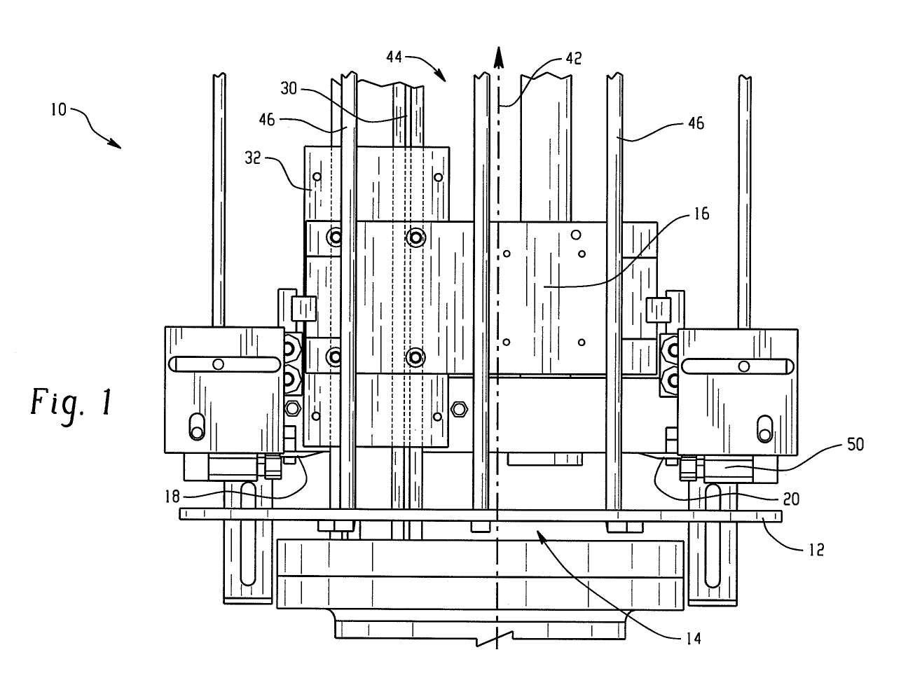

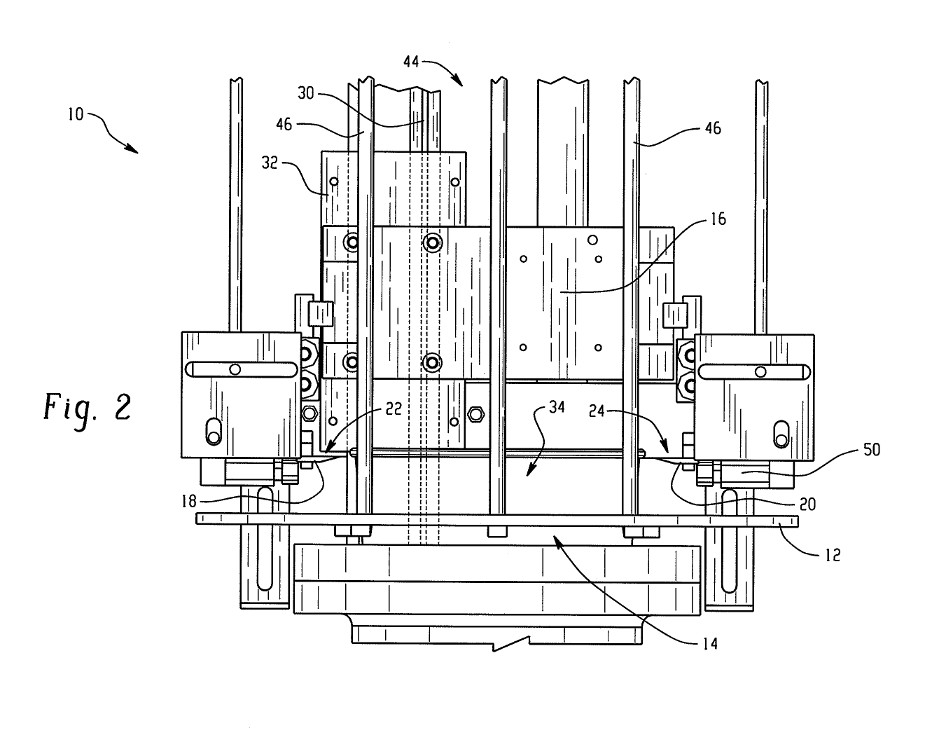

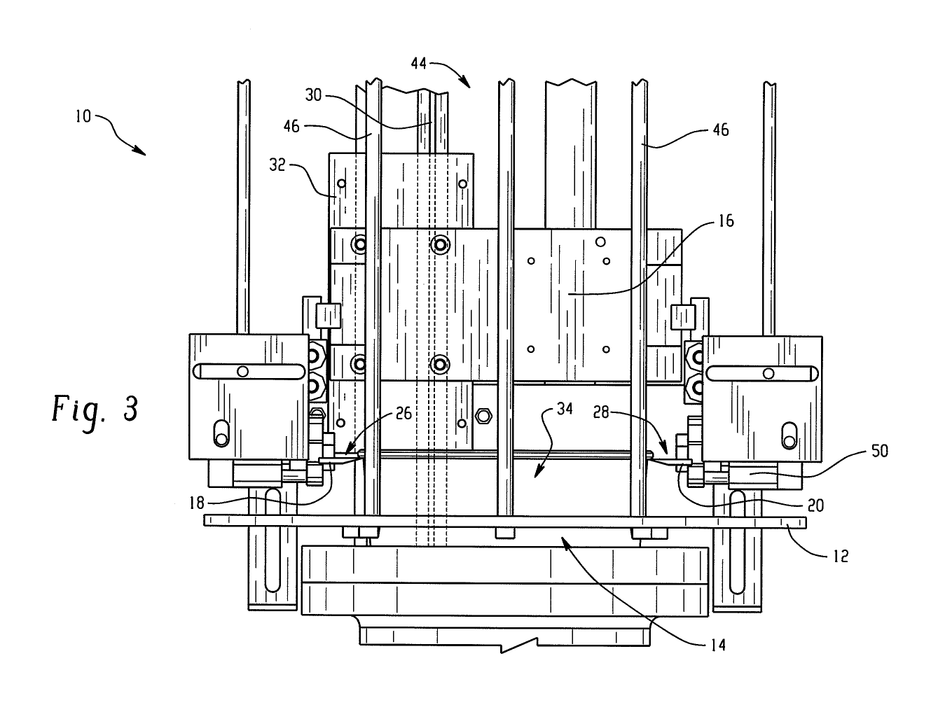

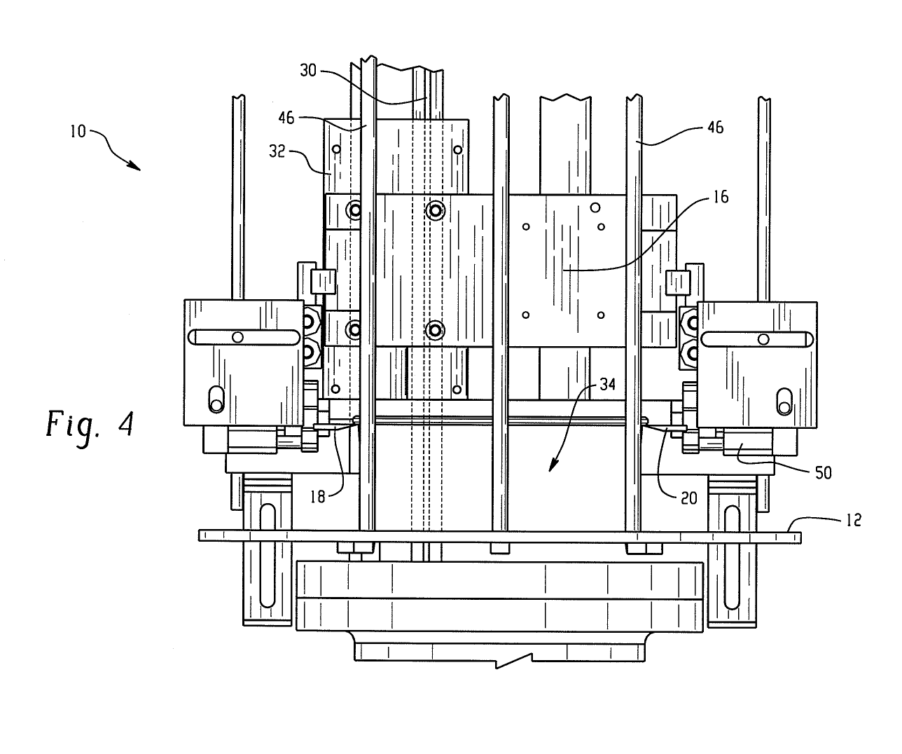

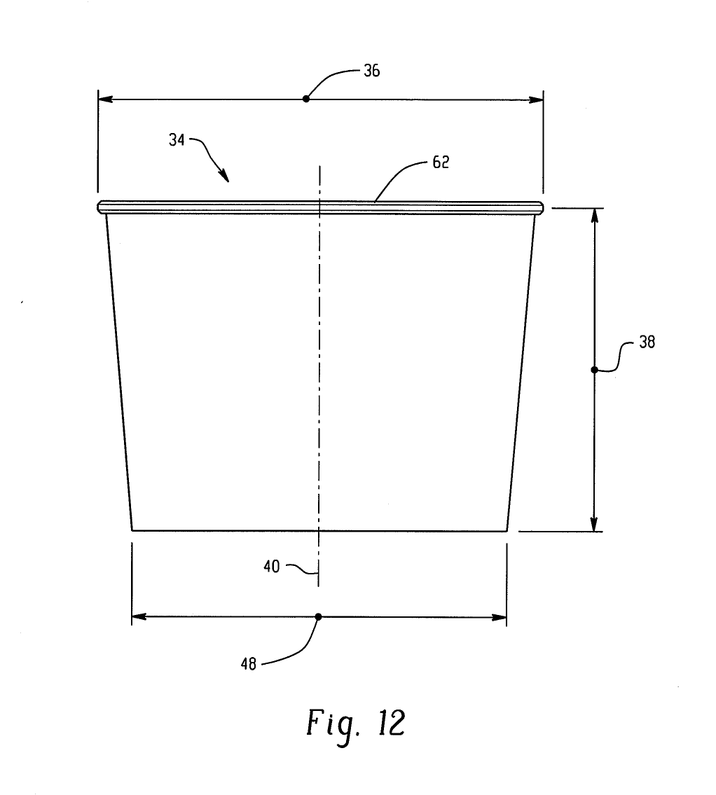

A collecting apparatus for receiving and moving open-ended containers is provided. In one embodiment, as shown in FIG. 1, the apparatus 10 comprises a frame 12 having a lengthwise axis 42 which defines an open-ended container travel path from an inlet end 14 to an outlet end 44, a carriage 16 mounted for reciprocating movement parallel to the travel path 42, and at least two retractable pushers 18,20 associated with the carriage for movement therewith. The width of the travel path 42 is defined as a first diameter 36 of the open-ended containers 34, as shown in FIG. 12. The pushers 18,20 are movable between respective retracted positions 22,24 outside of the travel path 42 (FIG. 2) and respective extended positions 26,28 in which the pushers are moved into the travel path 42 for engaging open-ended containers 34 (FIG. 3). The carriage 16 is moved along the travel path 42 toward the outlet end 44 with the pushers 18,20 in the respective extended positions 26,28 for moving open-ended containers 34 along the travel path 42 (FIG. 4).

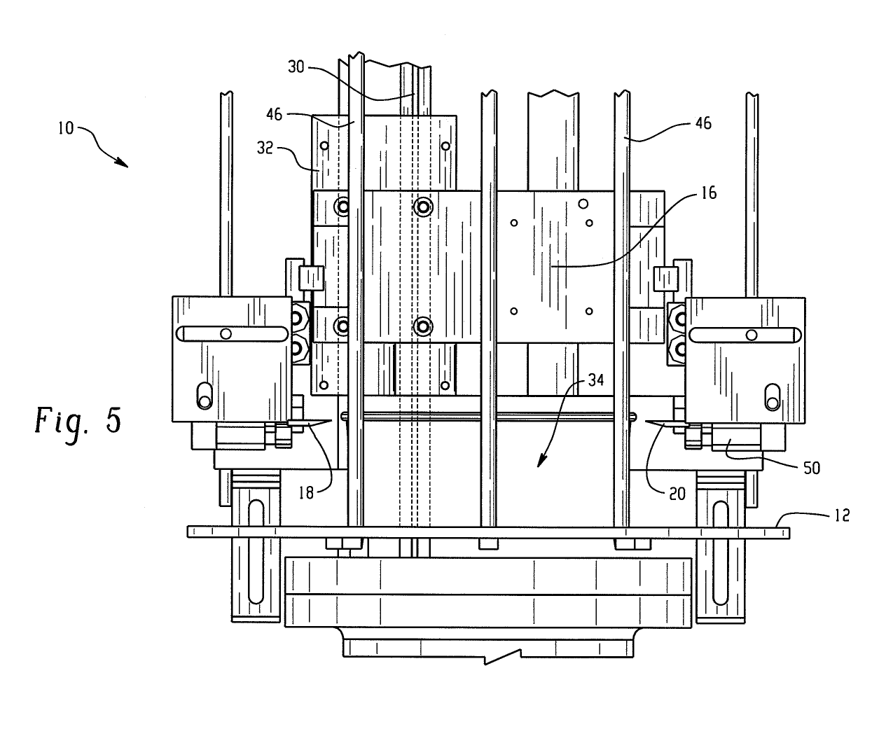

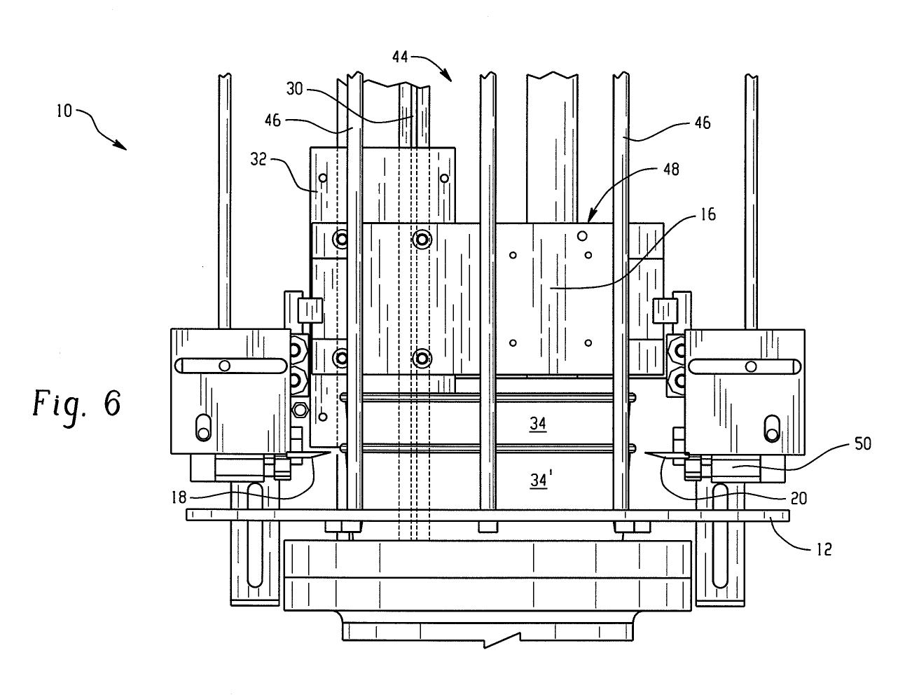

As shown in FIG. 5, the pushers 18,20 are moved to the respective retracted positions 22,24 during at least a substantial portion of carriage 16 movement along the travel path 42 toward the inlet end 14. In one embodiment, the pushers 18,20 are retracted when the carriage 16 is at a maximum travel distance from the inlet end 14 along the travel path 42. In another embodiment, the pushers 18,20 are retracted at a point along the travel path as the carriage 16 returns towards the inlet end 14. In another embodiment, the pushers 18,20 are retracted after the carriage reaches the inlet side 14, defining a home position 48 of the carriage 16, but before another open-ended container 34 enters the inlet side 14 (See FIG. 6).

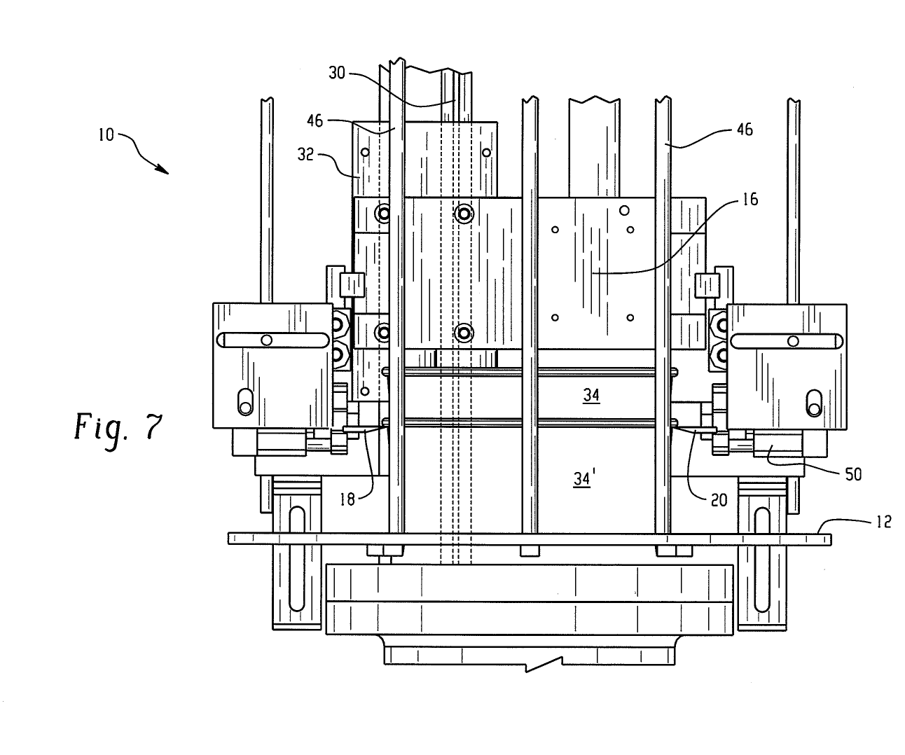

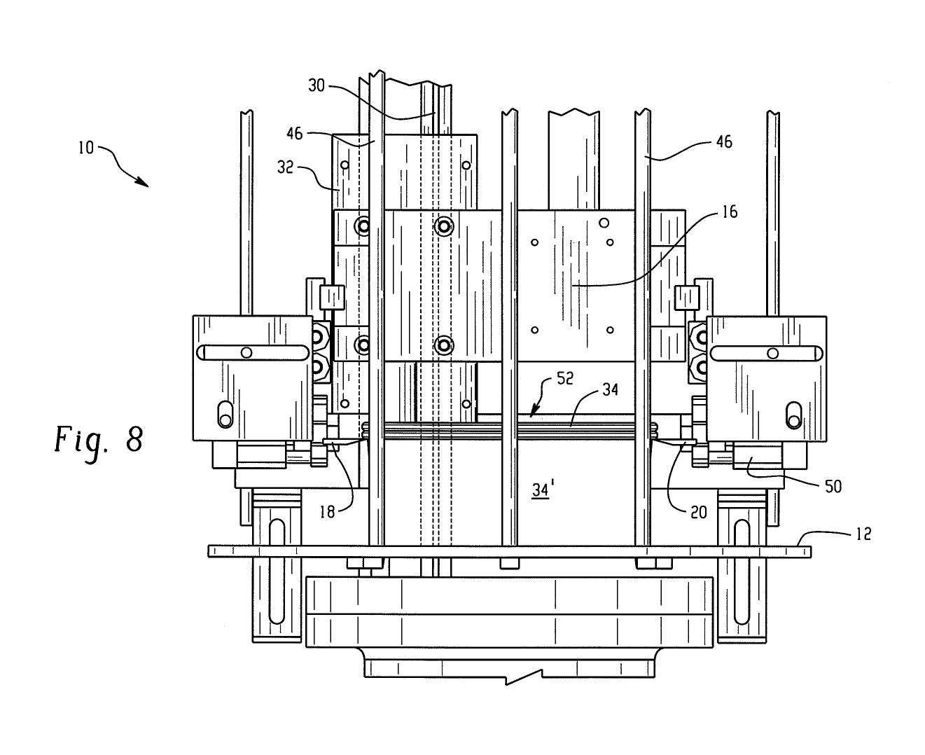

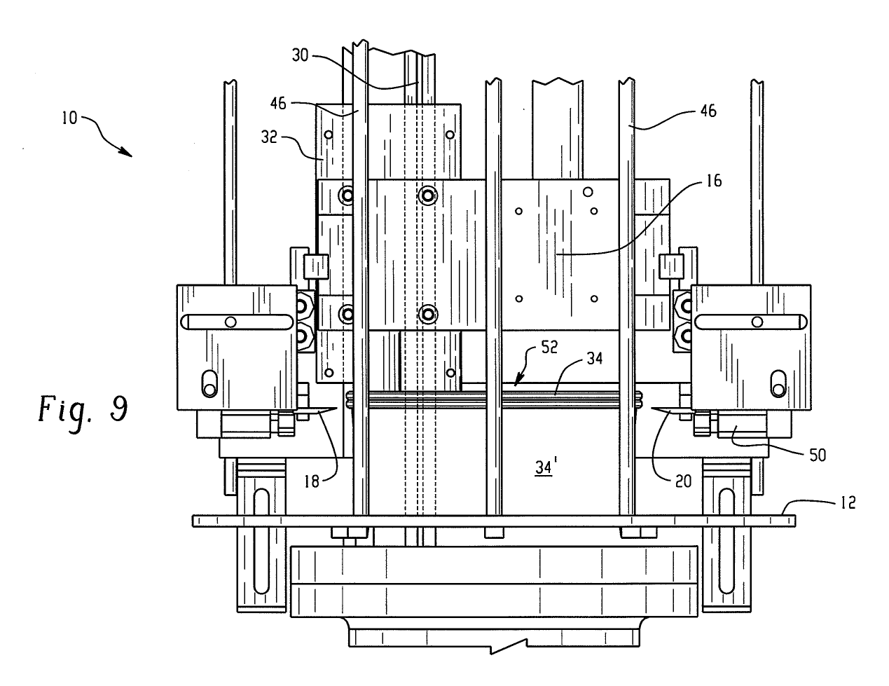

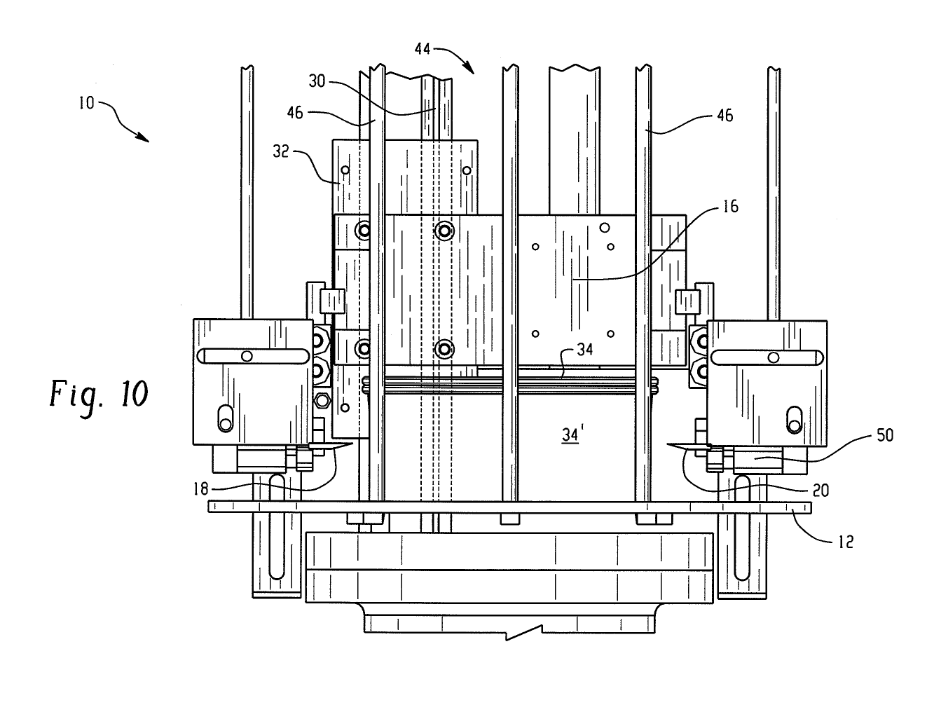

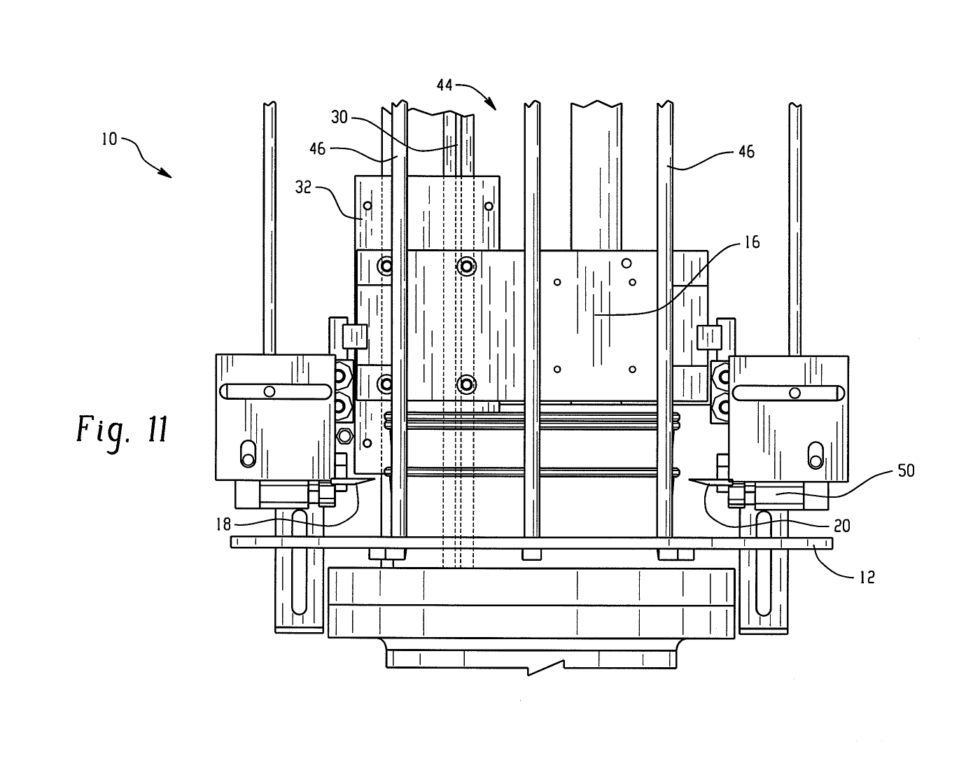

FIGS. 7-11 show the movement and collecting of a second or subsequent open-ended container 34′, by repeating the sequence described above. Specifically, the second or subsequent open-ended container 34′ enters the collecting apparatus 10, is engaged by the pushers 18,20 as described above, and is moved along the travel path 42 towards the outlet end 44, as described above. As the second or subsequent open-ended container 34′ is moved along the travel path 42, the first and the second open-ended containers 34,34′ are nested to result in the collection 52 of the open-ended containers. The pushers 18,20 are disengaged and the carriage returns to the home position, as described above.

In one embodiment, the collecting apparatus 10 further comprises a carriage track 30, as shown in FIG. 1. The carriage track 30 is substantially parallel to the travel path 42 and the carriage 16 is mounted for movement along the carriage track 30. In one embodiment, the collecting apparatus 10 further comprises a servo driven linear actuator 32 which provides reciprocating movement of the carriage 16 along the carriage track 30, as shown in FIG. 1.

The pushers 18,20 may be retracted 22,24 and extended 26,28 by pneumatic controls. In one embodiment, air cylinders 50 are provided, which are in association with the pushers 18,20, and provide pneumatic control of retraction and extension of the pushers 18,20. In one embodiment, the pushers 18,20 are extended 22,24 and retracted 26,28 by sliding the pushers in a direction perpendicular to the travel path 42. In another embodiment, one end of the pushers 18,20 is rotatably coupled to the carriage such that the pushers 18,20 are extended by rotating the uncoupled end of the pushers 18,20 into the travel path 42 and the pushers 18,20 are retracted by rotating the uncoupled end of the pushers 18,20 out of the travel path 42 (not shown). The illustrated collecting apparatus 10 has two pushers 18,20 but three, four, or more pushers could be used. In one embodiment, the pushers 18,20 are spaced such that the contact points between the pushers 18,20 and the open-ended containers 34 are substantially equidistant from one another. For example, when there are two pushers 18,20, the pushers 18,20 contact the substantially circular open-ended container 34 at a 3 o'clock and 9 o'clock positions, and when there are three pushers, the pushers contact the substantially circular open-ended container at a 2 o'clock, 6 o'clock, and 10 o'clock positions.

In operation, the collecting apparatus 10 includes a plurality of open-ended containers 34 positioned along the travel path, wherein each of the open-ended containers 34 has a diameter 36 comprising a rim 62 which is greater than its depth 38 and has a travel position comprising a depthwise axis 40 of the open-ended container 34 being substantially parallel to the lengthwise axis of the travel path 42, as shown in FIG. 12. In one embodiment, the engagement and movement of the open-ended containers 34 by the retractable pushers 18,20 aligns and nests the open-ended containers 34 and moves the nested containers toward the outlet end 44. The collecting apparatus 10 is capable of aligning the open-ended containers 34 by moving the container in a travel direction while maintaining the depthwise axis 40 being substantially parallel to the lengthwise axis of the travel path 42. The ability of the apparatus to move the open-ended containers 34 while maintaining the container's orientation is provided at least by the at least two pushers 18,20 engaging the open-ended container at substantially equidistant points on a diameter of the open-ended container 34. Also, a previously moved container provides a centering guide for a subsequently moved container, thus aligning the containers and further allowing the containers to be nested. In addition, supporting rods 46, a supporting tray (not shown), or a rail (not shown), as described below, may have a role in maintaining the open-ended container's 34 orientation such that the depthwise axis 40 is substantially parallel to the lengthwise axis of the travel path 42. By maintaining the orientation of the open-ended container 34, the containers 34,34′ are aligned with respect to one another such that movement of the containers 34 will result in the containers 34,34′ becoming nested.

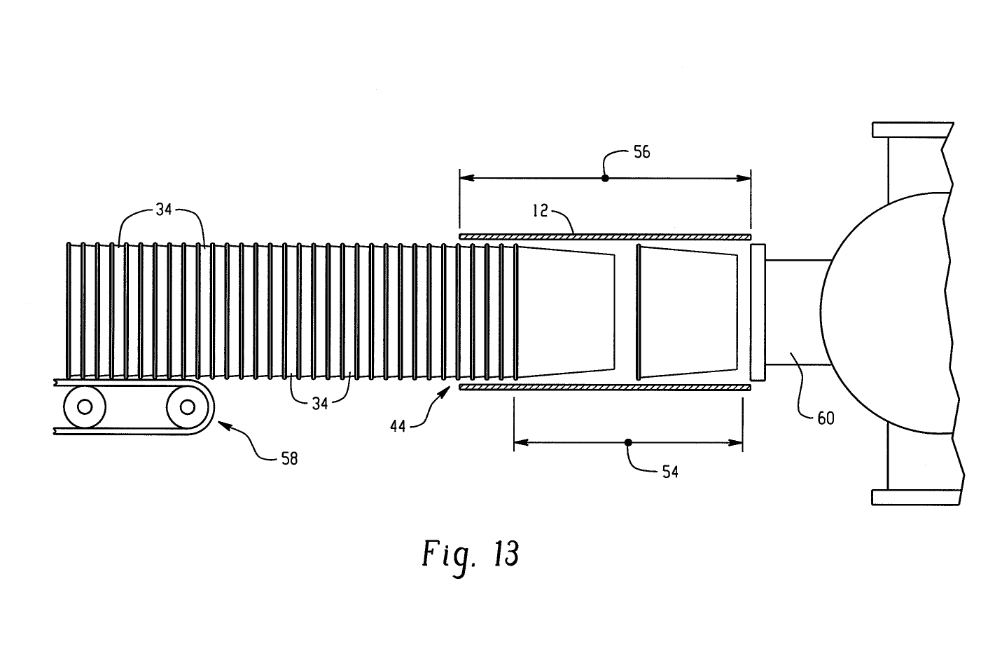

In one embodiment, a conveyor 58 is provided downstream of the frame 12, having a frame length 56, for receiving open-ended containers 34 from the outlet end 44 of the frame 12 (shown in FIG. 13). While downstream conveyor 58 is shown to the side of the containers for viewing, it may alternatively be located below the containers. In one embodiment, the downstream conveyor 58 moves a group of the open-ended containers 34 in a nested configuration away from the nested containers that are only moved by the carriage and pushers, indicated as 54. A counting, labeling, and/or packaging apparatus may be associated with the conveyor or downstream of the conveyor, as known in the art. Upstream of the collecting apparatus 10 may be a source of open-ended containers 34, such as a turret 60, which blows the formed open-ended containers into the inlet end 14 of the collecting apparatus 10.

In one embodiment, the frame 12 comprises at least two support rods 46 which are configured for supporting and/or aligning open-ended containers 34 in the travel position. In another embodiment, the frame 12 has three, four, five, six, or more support rods 46. In one embodiment, the support rods are configured such that the support rods 46 define an interior space between the rods 46. In one embodiment, a cross-section of the interior space is approximately equal to or slightly larger than the largest diameter 36 of the open-ended container 34. In another embodiment, a support tray is provided, either alone or in combination with the support rods 46, the support tray configured to support the open-ended container 34 (not shown). For example, the support tray may be configured to be an arc. In one embodiment, the curvature of the arc substantially corresponds to the curvature of the open-ended container 34. In one embodiment, the open-ended containers 34 in the travel position, rest on a flat surface having rails which help to confine the movement of the containers to substantially only a travel direction (not shown).

Each of the open-ended containers 34 may include a peripheral rim lip that defines the largest diametric dimension of the open-ended container 34 and the pushers 18,20 engage with the lip when the carriage 16 is moving the open-ended containers 34. The open-ended containers further comprise a second diameter 48 corresponding to the bottom of the open-ended container when the container is in an up-right configuration. In one embodiment, the second diameter 48 of the open-ended containers 34 is smaller than the diameter 36 of the open-end of the open-ended containers 34. In this embodiment where the second diameter is smaller than the first diameter, the sides of the open-ended container are not perpendicular to a bottom of the container. In one embodiment, the side of the container angles from the bottom of the container to a point near the open-end of the open-ended container. This configuration where the sides of the open-ended container are not parallel to the travel path allows the containers to be nested and collected.

As can be appreciated, the above-described collecting apparatus 10 can provide for processing, for example, moving, collecting, and/or nesting, of open-ended containers, for example, in a packaging operation. The collecting apparatus 10 may be particularly useful in processing open-ended containers having a diameter which is greater than its depth, such as is common with tubs. By moving and nesting the open-ended containers using the collecting apparatus 10, the containers can be collected for downstream use, such as packaging.

In one embodiment, a method for moving and collecting open-ended containers is provided. In one embodiment, the method comprises engaging at least two points of a portion of a first open-ended container 34 at a start position with at least two pushers 18,20, each pusher associated with a carriage 16 which is capable of reciprocating movement between the start position and an end position, and moving the first open-ended container 34 in a travel path direction 42 away from the start position toward the end position using the two pushers 18,20. The open-ended container 34 is moved in a travel position where a depthwise axis 40 of the container 34 is substantially parallel to the travel path 42 direction during the moving.

Next, the at least two pushers 18,20 are disengaged from the portion of the first open-ended container 34 and the carriage 16 returns to the start position. The pushers 18,20 are disengaged from the portion of the first open-ended container 34 by retracting the pushers 22,24 outside of the travel path. In one embodiment, the pushers are retracted past at least a portion of a second open-ended container 34′. In one embodiment, the disengaging of the at least two pushers 18,20 from the portion of the first open-ended container 34 and the returning of the carriage 16 to the start position occur independently of one another.

When the carriage 16 is at the start position, the pushers 18,20 are again extended 26,28 and engage at least two points on the second open-ended container 34′ and the second open-ended container 34′ is moved toward the first open-ended container 34 using the two pushers 18,20 so as to nest the second open-ended container 34′ with the first open-ended container 34. This process can be repeated to result in moving a plurality of open-ended containers 34 in a travel path direction 42 which results in nesting or collecting of the open-ended containers 34.

In one embodiment, the nested open-ended containers 34,34′ are further moved downstream using a conveyor.

It is to be clearly understood that the above description is intended by way of illustration and example only and is not intended to be taken by way of limitation, and that changes and modifications are possible.

What is claimed is:

1. A collecting apparatus for receiving and moving open-ended containers, the apparatus comprising
a frame having a lengthwise axis which defines an open-ended container travel path from an inlet end to an outlet end,
a carriage mounted for reciprocating movement parallel to the travel path, and
at least two retractable pushers associated with the carriage for movement therewith, the pushers movable between respective retracted positions outside of the travel path and respective extended positions in which the pushers are moved into the travel path for engaging containers, wherein the carriage is moved along the travel path toward the outlet end with the pushers in the respective extended positions for moving containers along the travel path.

2. The apparatus of claim 1 wherein the pushers are moved to the respective retracted positions during at least a substantial portion of carriage movement along the travel path toward the inlet end.

3. The apparatus of claim 1 further comprising a carriage track, wherein the carriage track is substantially parallel to the travel path and the carriage is mounted for movement along the carriage track.

4. The apparatus of claim 3 further comprising a servo driven linear actuator which provides reciprocating movement of the carriage along the carriage track.

5. The apparatus of claim 1 wherein the retractable pushers are retracted and extended by pneumatic controls.

6. The apparatus of claim 1, further comprising:
a plurality of open ended containers positioned along the travel path, wherein each of the open-ended containers has a diameter which is greater than its depth and has a travel position comprising a depthwise axis of the open-ended container being substantially parallel to the lengthwise axis of the travel path.

7. The apparatus of claim 6 wherein the engagement and movement of the open-ended containers by the retractable pushers aligns and nests the open-ended containers and moves the nested containers toward the outlet end.

8. The apparatus of claim 1 further comprising a conveyor downstream of the frame for receiving containers from the outlet side of the frame.

9. The apparatus of claim 6 wherein the frame comprises at least two support rods which are configured for supporting open-ended containers in the travel position.

10. The apparatus of claim 5 wherein each of the open-ended containers comprises a peripheral rim lip that defines the largest diametric dimension of the open-ended container and the pushers engage with the lip when the carriage is moving containers.

11. A method of collecting and moving open-ended containers of a type in which a container diameter is greater than a container depth, comprising
engaging at least two points of a portion of a first open-ended container at a start position with at least two pushers, each finger associated with a carriage which is capable of reciprocating movement between the start position and an end position,
moving the first open-ended container in a travel path direction away from the start position toward the end position using the two pushers, a depthwise axis of the container being substantially parallel to the travel path direction during the moving,
disengaging the at least two pushers from the portion of the first open-ended container and returning the carriage to the start position, including retracting the pushers past at least a portion of a second open-ended container, and
extending the pushers and engaging at least two points on the second open-ended container with the pushers;
moving the second open-ended container toward the first open-ended container using the two pushers so as to nest the second open-ended container with the first open-ended container.

12. The method of claim 11 wherein the movement of the carriage is facilitated by an association with a carriage track, wherein the carriage track is substantially parallel to the travel path.

13. The method of claim 12 wherein a servo driven linear actuator provides reciprocating movement of the carriage along the carriage track.

14. The method of claim 13 wherein the at least two pushers engage and disengage the portion of the open-ended containers by moving the at least two pushers into and out of the travel path using a pneumatic system.

16. The method of claim 11 wherein the travel path is defined at least in part by a frame comprising support rods.

17. The method of claim 11 wherein the disengaging of the at least two pushers from the portion of the first open-ended container and the returning of the carriage to the start position occur independently of one another.

18. The method of claim 11 further comprising moving the open-ended containers downstream of the end position using a conveyor.
